(19) United States
(12) Patent Application Publication
(10) Pub. No.: US 2017/0369196 A1
(43) Pub. Date: Dec. 28, 2017

(54) THERMOFORMING TRIM REMOVAL SYSTEMS AND METHODS

(71) Applicant: EVO Development, LLC, Bethlehem, PA (US)

(72) Inventor: Robert Dean Robbins, Bethlehem, PA (US)

(73) Assignee: EVO Development, LLC, Bethlehem, PA (US)

(21) Appl. No.: 15/533,589

(22) PCT Filed: Dec. 8, 2015
(86) PCT No.: PCT/US15/64496

§ 371 Date: Jun. 6, 2017

Related U.S. Application Data
(60) Provisional application No. 62/088,975, filed on Dec. 8, 2014.

(51) Int. Cl. B65B 61/06; B29C 51/18; B65B 7/16; B65B 65/02

(52) U.S. Cl. CPC B65B 61/06; B65B 65/02; B29C 51/18; B65B 7/16

(57) ABSTRACT

A system and method of providing a secondary means for removing thermoforming trim material from a continuous-loop clamping chain (202) having clamps (302) biased to engage a clamp grip surface (314). A cam (400), attached to a sprocket located downstream from a cutting station (114) but upstream from a forming station (102), provides an outer surface that engages a clamp release surface (306) as the link member (300) passes over the sprocket.

### BACKGROUND

Thermoforming involves heating plastic materials until pliable, then forming the plastic into a product. For example, thermoforming is used in packaging systems both to create molded containers and to seal the tops of containers with a film of plastic material. When thermoforming a product or sealing a container, excess plastic material (“trim”) is cut away and removed.

For example, trim is often excess plastic material at the outer edges of a product that is held by a fixed clamping or piercing process to convey the product through one or more machines of a manufacturing and packaging process. For example, the outer edges of the plastic material might be held in place by a series of clamps or a series of spikes on an endless chain or belt of a circulating feed system. An endless chain of the circulating feed system is typically located along each lateral edge of a conveyor to engage and hold the edges of the product to the chains in order to feed the product through the machines of the manufacturing process. Once the top of a container is sealed with plastic film, the outer edge trim is cut away while still held by the clamps or spikes. Before the endless chain is circulated back to the beginning of the machine, the trim material must be removed from the clamps or spikes to avoid getting caught in the sprockets of the endless chain. That can lead machine damage, stretching of chain requiring costly replacement, sanitation issues and can present a significant operational cost if the machine must be shut down to clear a blockage. Existing systems for removing thermoforming trim typically include a vacuum system to suction the trim into a waste receptacle having a removable rigid collection bin or reels onto which the trim is rolled. For example, the clamps might be opened to allow the vacuum system to remove the trim. However, such a system might not effectively remove all the trim, for example if a piece of trim is not effectively released for a variety of typical reasons. These issues might be especially prevalent in machines used on the food industry. There exists an unmet need for improved, cost-effective systems and methods for removing and disposing of thermoforming trim that overcome deficiencies of the prior art.

### BRIEF DESCRIPTION OF THE DRAWING FIGURES

Other aspects, features, and advantages of described embodiments will become more fully apparent from the following detailed description, the appended claims, and the accompanying drawings in which like reference numerals identify similar or identical elements.

FIG. 1 shows a schematic side view of a thermoforming trim removal system in accordance with exemplary embodiments;

FIG. 2 shows a partial top perspective view of a thermoforming trim removal system in accordance with exemplary embodiments;

FIG. 3 shows a partial perspective view of a transport clamp chain and drive sprocket of a thermoforming trim removal mechanism in accordance with exemplary embodiments;

FIG. 4 shows a perspective view of a sprocket cam of a thermoforming trim removal mechanism in accordance with exemplary embodiments;

FIG. 5 shows a perspective view of the sprocket cam of FIG. 4 in an assembled configuration with the drive sprocket of FIG. 3 in accordance with exemplary embodiments; and

FIG. 6 is a flowchart illustrating steps for removing trim by a thermoforming trim removal system in accordance with exemplary embodiments.

### DETAILED DESCRIPTION

The ensuing detailed description provides preferred exemplary embodiments only, and is not intended to limit the scope, applicability, or configuration of the invention. Rather, the ensuing detailed description will provide those skilled in the art with an enabling description for implementing the exemplary embodiments. It being understood that various changes may be made in the function and arrangement of elements without departing from the spirit and scope of the invention, as set forth in the appended claims.

To the extent directional terms are used in the specification and claims to describe portions of the present invention (e.g., upper, lower, etc.), these terms are merely intended to assist in describing and claiming the invention and are not intended to limit the invention in any way. In the figures, elements that are similar to those of other embodiments of the present invention are represented by reference numerals increased by a value of 100. Such elements should be regarded as having the same function and features unless otherwise stated or depicted herein, and the discussion of such elements may therefore not be repeated for multiple embodiments. In addition, reference numerals that are introduced in the specification in association with a drawing figure may be repeated in one or more subsequent figures without additional description in the specification in order to provide context for other features.

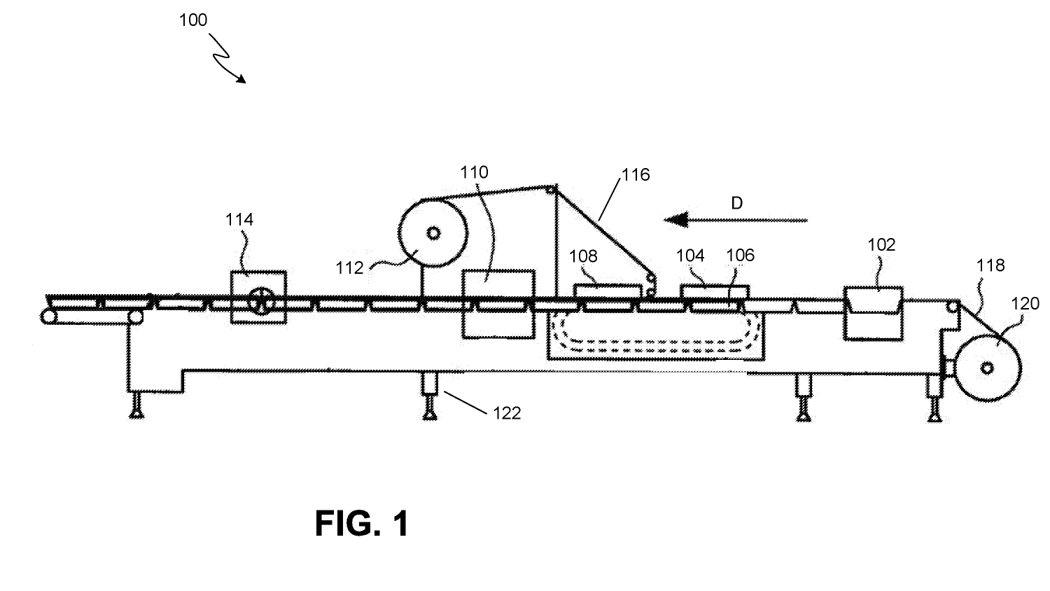

FIG. 1 shows a schematic view of thermoform packaging machine 100. As shown, thermoform packaging machine 100 comprises forming station 102, loading station 104, pre-sealing station 108, sealing station 110, and cutting station 114, which are arranged on machine frame 122 in sequence indicated by production direction D. In general, thermoform packaging machine 100 is employed to automatically package one or more products within a thermoformed package by conveying the products through thermoform packaging machine 100 in production direction D. For example, forming station 102 thermoforms pockets in a packaging material to be filled with one or more products. The one or more products are placed in the thermoformed pockets at loading station 104. Pre-sealing station 108 covers the products that are placed in the packaging material, for example with film or foil 116 from material roll 112. Sealing station 110 might typically vacuum seal the package and cover material, for example by removing or substituting the atmosphere in the troughs by an exchange gas or gas mixture, for example, by gas flushing. Once the package is sealed, cutting station 114 removes excess cover material (“trim”). For example, cutting station 114 might perform transverse cutting unit and longitudinal cutting to remove trim from all sides of the packaged products and to separate adjacent packages. Film or foil 116 might be made of one or more polyethylene plastics such as high-density polyethylene (HDPE), low-density polyethylene (LDPE), and linear low-density polyethylene (LLDPE), as well as known biodegradable plastics or other flexible materials known in the art (i.e., polymeric and/or non-polymeric) having strength characteristics suitable for use in thermoforming packaging.

Although not shown in FIG. 1, packaging machine 100 might be coupled to a conveyor belt for transporting finished packages that have been separated from one another. Although not shown in FIG. 1, thermoform packaging machine 100 generally will also include a controller for controlling and monitoring the processes taking place in thermoform packaging machine 100 and displaying indications to an operator of thermoform packaging machine 100.

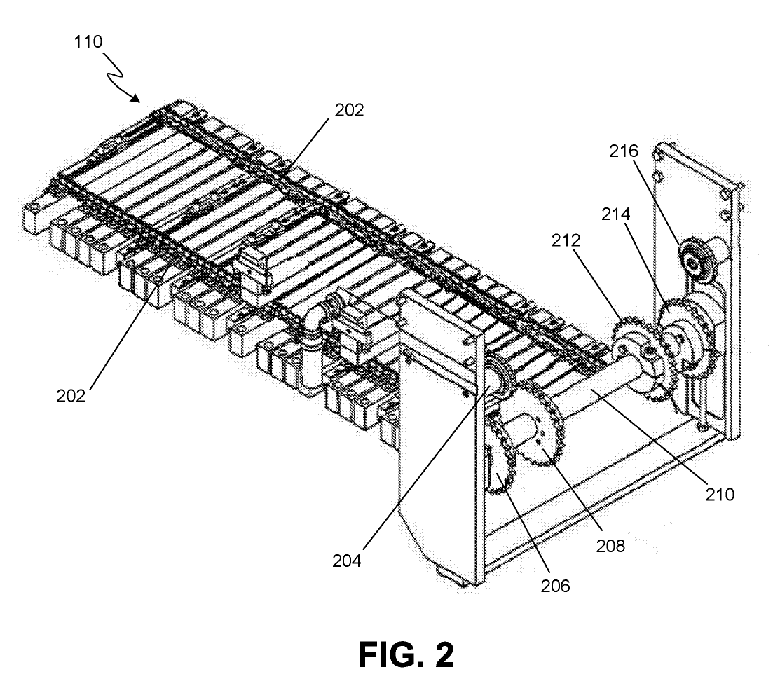

As shown in FIG. 1, thermoform packaging machine 100 includes sealing station 110 and cutting station 114. As shown in FIG. 2, sealing station 110 and cutting station 114 include film conveying units 202 that grips the film 116 and advances it in production direction D to cover the packages. As described herein, the film conveying unit might be configured, for example, as transport clamp chains arranged on either side of the film 116 within machine frame 122. In thermoforming machines of the prior art, it is common for excess portions of film 116 (“trim”) cut away in cutting station 114 not to release from the transport clamps and to wind back into the sprockets of sealing station 110 and/or cutting station 114 for advancing the transport clamp chains (e.g., sprockets 204, 206, 208, 212, 214 and 216, or equivalent sprockets, not shown, at the opposing end of cutting station 114). This is a significant cause of down time for thermoform packaging machines of the prior art.

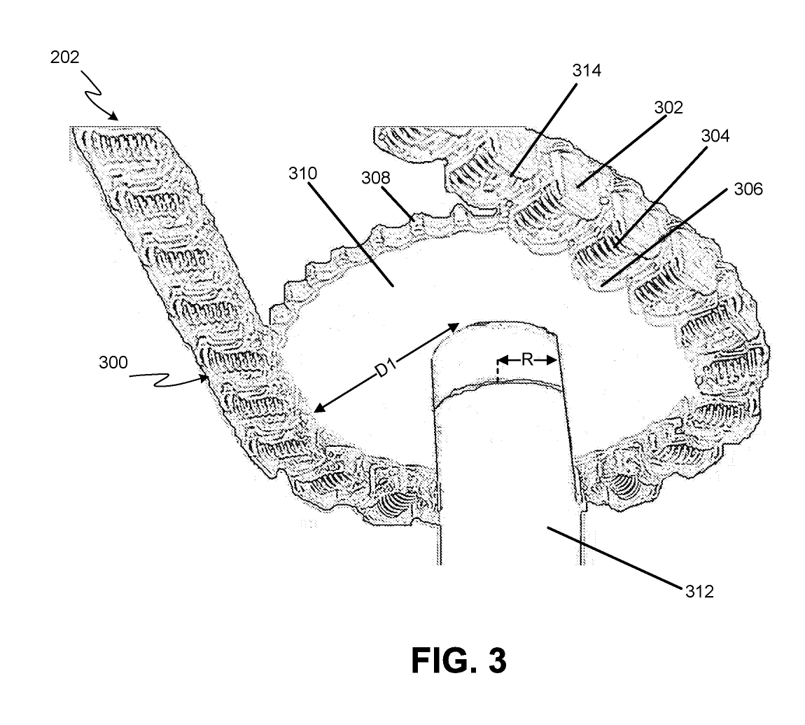

FIG. 3 shows a perspective view of a transport clamp chain 202 and drive sprocket 310 of thermoform packaging machine 100. As shown in FIG. 3, transport clamp chain 202 includes a plurality of clamp link members 300 that is driven to move products along thermoform packaging machine 100 in production direction D by drive sprocket 310 having a plurality of sprocket teeth 308. Drive sprocket 310 is driven by drive axle 312, which has an outer radius of R. Each clamp link member 300 includes clamp 302, spring 304, clamp release surface 306, and clamp grip surface 314. Spring 304 operates to keep clamp 302 closed against clamp grip surface 314 (e.g., to grip thermoform film 116 to package items in thermoform packaging machine 100. Clamp 302 remains closed unless clamp release surface 306 is pressed, which opens clamp 302 upward from clamp grip surface 314. Drive sprocket 310 has a distance, D1, between its center point and the bottom surface of each clamp link member 300 (e.g., clamp release surface 306). In thermoform packaging machines of the prior art, clamp 302 of each of the various clamp link members 300 might be opened, for example by passing clamp release surface 306 over a raised surface, after trim is cut away from the packages at cutting station 114. However, thermoform packaging machines of the prior art often fail to effectively remove all the trim, for example if a piece of trim is stuck to a clamp or a clamp fails to open. This situation might occur since the thermoform film is heated and might be sticky, and might be especially prevalent in machines for processing sticky items, such as food items. Stuck trim material can then get caught in the various sprockets (e.g., drive sprocket 310) and clamp chain 202, which can result in thermoform packaging machine 100 needing to be taken out of service for cleaning and repair.

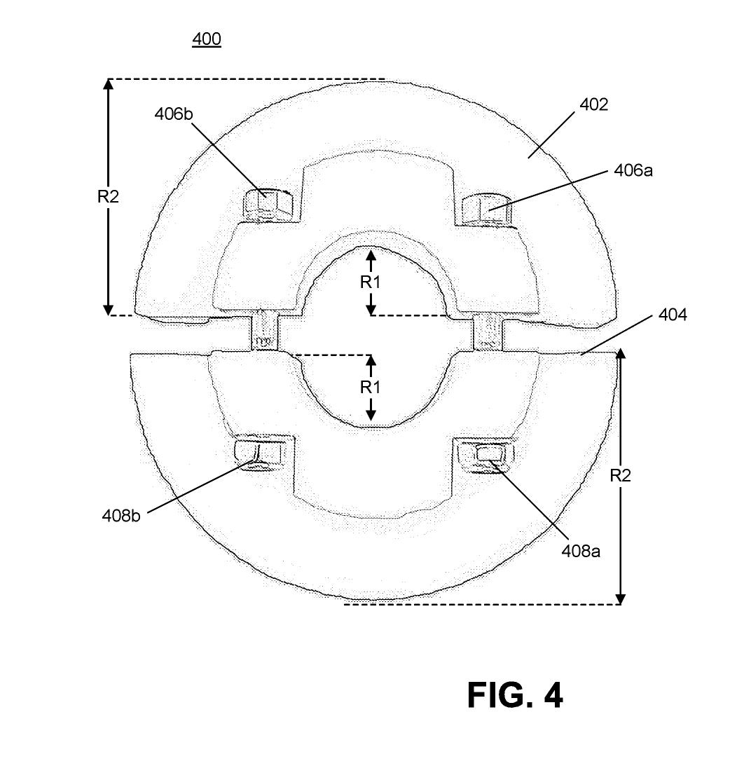

FIG. 4 shows a perspective view of sprocket cam 400 for use with drive sprocket 310 to prevent stuck trim material from getting stuck in drive sprocket 310. As shown in FIG. 4, sprocket cam 400 might typically be implemented in two halves, shown as first half 402 and second half 404, which are held together, for example on drive axle 312, by bolts 406a and 406b with nuts 408a and 408b. As shown in FIG. 4, each of first half 402 and second half 404 have a cutout having a radius of R1. In exemplary embodiments, R1 is substantially equal to R, the radius of drive axle 312 such that sprocket cam 400 (e.g., both first half 402 and second half 404) can be tightly clamped to drive axle 312. Also as shown in FIG. 4, each of first half 402 and second half 404 have a radius of R2. In exemplary embodiments, R2 is slightly larger than the distance, D1, between the center of drive sprocket 310 and the bottom surface of each clamp link member 300 (e.g., clamp release surface 306). Thus, sprocket cam 400 is sized to release each clamp 302 by pressing against clamp release surface 306 as each clamp link member comes into contact with cam 400 as transport clamp chain 202 is driven by drive sprocket 310. Further, R2 might be smaller than the radius of drive sprocket 310, such that the clamp link members 300 do not become disengaged from sprocket teeth 308 of drive sprocket 310 as each clamp link member comes into contact with cam 400 as transport clamp chain 202 is driven by drive sprocket 310.

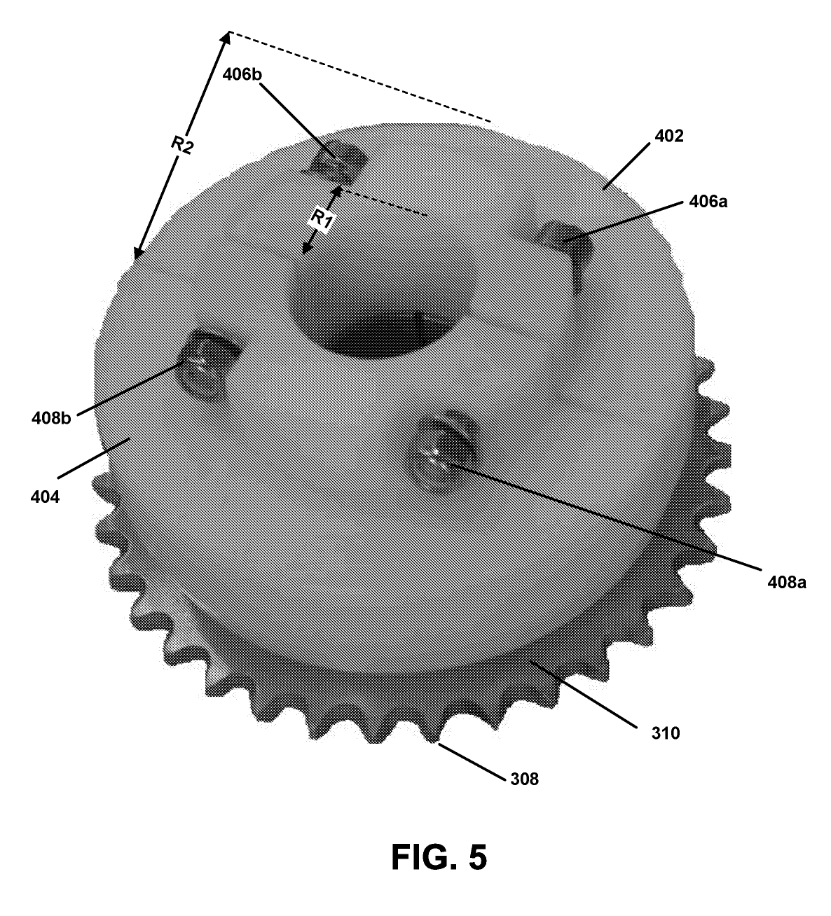

FIG. 5 shows a perspective view of the sprocket cam of FIG. 4 in an assembled configuration with drive sprocket 310. As shown in FIG. 5, R2 is slightly larger than the distance, D1, between the center of drive sprocket 310 and the bottom surface of each clamp link member 300 (e.g., clamp release surface 306). Thus, sprocket cam 400 is sized to release each clamp 302 by pressing against clamp release surface 306 as each clamp link member comes into contact with cam 400 as transport clamp chain 202 is driven by drive sprocket 310. Further, R2 might be smaller than the radius of drive sprocket 310, such that the clamp link members 300 do not become disengaged from sprocket teeth 308 of drive sprocket 310 as each clamp link member comes into contact with cam 400 as transport clamp chain 202 is driven by drive sprocket 310.

Thus, as shown in FIGS. 4 and 5, sprocket cam 400 forces open each clamp link member 300, thus reducing or eliminating the possibility of trim material not being removed due to a stuck or unopened clamp. Further, sprocket cam 400 is installed on at least the first drive sprocket after the trim material is cut (e.g., after cutting station 114) to prevent trim material from becoming stuck in subsequent drive sprockets of thermoform packaging machine 100. In some embodiments, sprocket cam 400 might be installed on one or more additional drive sprockets of thermoform packaging machine 100, such that, at each drive sprocket, each clamp link member 300 is opened so that excess trim material can be removed. Also, in this embodiment, the sprocket cam 400 is designed to be retrofitted to a sprocket. Alternatively, the sprocket cam 400 structure could be provided as an integral part of the drive sprocket 310 and drive axle 312 or another sprocket and axle. Accordingly, the present invention provides a second cam-release surface that engages the clamp chain 202 after the clamp chain has come in contact with a primary cam-release, which is typically located just after the cutting station 114.

Although not shown in FIG. 3, a trim removal system might be placed at a bottom of drive sprocket 310 such that any trim material can be removed before transport clamp chain 202 is fed around any additional sprockets of thermoform packaging machine 100. In exemplary embodiments, the trim material might be removed by a vacuum system, for example such as described in related U.S. Patent Application No. Publication No. 2014/0345078 A1, published Nov. 2, 2014, which is hereby incorporated by reference as if fully set forth. In other embodiments, an air blower might be employed rather than a vacuum system to blow trim material from the clamps. In yet other embodiments, a combination of an air blower and vacuum system might be employed. Further, although shown in FIGS. 4 and 5 as a sprocket cam, other implementations of actuators to release the clamps, such as a rod or bar, might be employed.

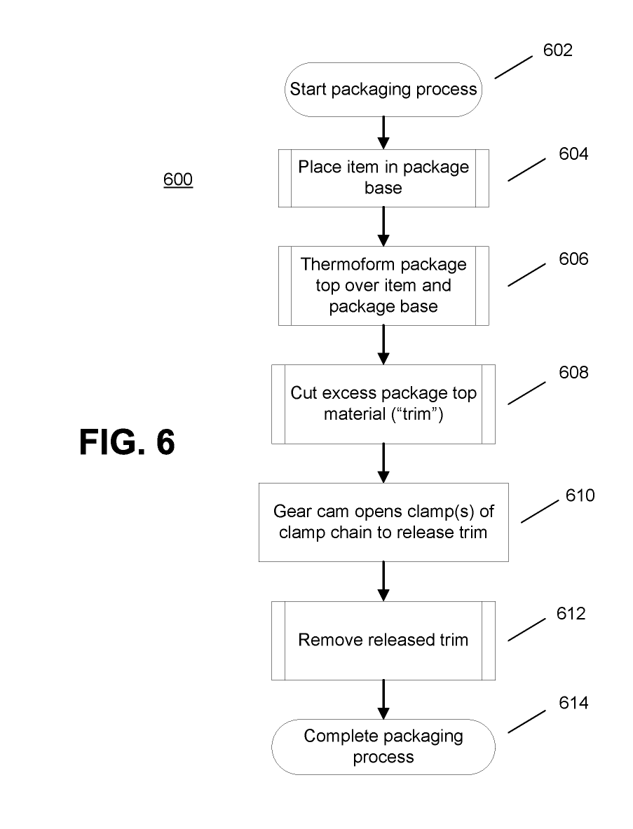

FIG. 6 is a flowchart of exemplary thermoform packaging process 600. At step 602, the packaging process is started, for example by thermoform packaging machine 100. At step 604, thermoform packaging machine 100 places an item to be packaged in a container base, for example at loading station 104 as described in regard to FIG. 1. At step 606, thermoform film 116 is placed over the item and container base to allow the item to be sealed within the container base, for example at pre-sealing station 108 as described in regard to FIG. 1. At step 606, the container might be vacuum sealed, for example at sealing station 100 as described in regard to FIG. 1. At step 608 trim material is removed from the sides of the packaged products and adjacent packages are separated, for example at cutting station 114 as described in regard to FIG. 1. At step 610, sprocket cam 400 opens each clamp 302 of each clamp link member 300 as they are driven by drive sprocket 310. At step 612, the trim material is removed by a trim removal system. For example, the trim removal system might be placed at a bottom of drive sprocket 310 such that any trim material can be removed before transport clamp chain 202 is fed around any additional sprockets of thermoform packaging machine 100. In exemplary embodiments, the trim material might be removed by a vacuum system, for example such as described in related U.S. patent application Ser. No. 14/284,698 filed May 22, 2014. At step 614, packaging process 600 completes.

Thus, as described herein, described embodiments provide an improved trim material removal system to prevent trim material from becoming lodged in the sprockets of the thermoform packaging machines, thus reducing production down time and costs.

The terms “downstream” and “upstream”, as used in the specification and claims, mean the relative location of two elements along the path of travel of the clamping chains, taking into account their direction of travel. For example, if the cutting station 114 is referred to as being downstream from the sealing station 110, this means that a clamp link member 300 will pass through the cutting station 114 station after passing through the sealing station 110 when the chain is moving in its normal direction of travel.

Reference herein to “one embodiment” or “an embodiment” means that a particular feature, structure, or characteristic described in connection with the embodiment can be included in at least one embodiment. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various described embodiments.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard. Unless explicitly stated otherwise, each numerical value and range should be interpreted as being approximate as if the word “about” or “approximately” preceded the value of the value or range.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports might be referred to by the same name and are interchangeable for purposes here.

It will be further understood that various changes in the details, materials, and arrangements of the parts that have been described and illustrated in order to explain the nature of the described embodiments might be made by those skilled in the art without departing from the scope expressed in the following claims.

### Aspects of the Invention

Additional aspects of the invention include:

Aspect 1: A thermoforming system comprising:

a frame;

a forming station, a loading station, and a sealing station;

at least one chain, each of the at least one chain comprising a continuous loop having a plurality of links, each of the plurality of links having a clamp that is biased to engage a clamp grip surface and a clamp release surface that is operationally configured to cause the clamp to move out of contact with the clamp grip surface when the clamp release surface is pressed toward the clamp;

a plurality of sprockets including a drive sprocket, each of the plurality of sprockets being attached to an axle that is supported by the frame, each of the plurality of sprockets having teeth adapted to engage the at least one chain, the drive socket being connected to a drive mechanism operationally configured to provide a rotational movement of the drive socket in a first rotational direction, thereby causing each of the at least one chain to move in a first direction of travel;

a cutting station operationally configured to cut a trim portion away from a remaining portion of a thermoformed package being conveyed by the at least one chain, the cutting station including a first clamp disengagement device operationally configured to cause the clamp to disengage the clamp grip surface of each of the plurality of links as each of the plurality of links passes through the cutting station;

a supplemental clamp disengagement device comprising a cam located adjacent to at least one of the plurality of sprockets located between the cutting station and the forming station, the cam being affixed to the axle to which the at least one of the plurality of sprockets is attached, the cam having an outer surface that is positioned to engage the clamp release surface of each of the plurality of links as each of the plurality of links pass over the at least one of the plurality of sprockets, thereby causing the clamp to temporarily disengage the clamp grip surface.

Aspect 2: The system of any of aspects 1 and 3-5, wherein the cam is located adjacent to the drive sprocket.

Aspect 3: The system of any of aspects 1-2 and 4-5, wherein the cam comprises a plurality of parts that are removably attachable to each other, thereby enabling the cam to be installed on the axle while the at least one of the plurality of sprockets is installed on the axle.

Aspect 4: The system of any of aspects 1-3 and 5, further comprising a trim separation device that is operationally configured to apply a force to the trim portion in a direction that will cause the trim portion to disengage from the clamp grip surface and at a location in which the clamp is disengaged from the clamp grip surface of each of the plurality of links as each of the plurality of links pass over the at least one of the plurality of sprockets.

Aspect 5: The system of any of aspects 1-4, wherein the trim separation device comprises a blower or vacuum.

Aspect 6: A method of operating a thermoform film machine, the method comprising the steps of:

(a) driving at least one chain in a direction of travel in a continuous loop, each of the at least one chain comprising a continuous loop having a plurality of links, each of the plurality of links having a clamp that is biased to remain in contact with a clamp grip surface and a clamp release surface that is operationally configured to cause the clamp to move out of contact with the clamp grip surface when the clamp release surface is pressed toward the clamp;

(b) forming at least one pocket in a package material at a forming station located along the continuous loop;

(c) sealing a cover over the package material at a sealing station;

(d) separating a trim portion from a thermoformed container at a cutting station after performing step (c);

(e) retaining the trim portion between a clamp and clamp grip surface of at least one link of the at least one chain after performing step (d);

(f) causing the clamp of each of the plurality of links to disengage from the clamp grip surface at a location downstream from step (d);

(g) allowing the clamp of each of the plurality of links to reengage the clamp grip surface at a location downstream from step (f) and upstream of step (h); and

(h) causing the clamp of each of the plurality of links to disengage from the clamp grip surface at a location downstream from the step (g) and upstream from the forming station.

Aspect 7: The method of any of aspects 6 and 8-11, wherein step (h) comprises providing a cam located adjacent to a sprocket, engaging a clamp release surface with an outer surface of the cam, thereby causing the clamp of each of the plurality of links to disengage from the clamp grip surface at a location downstream from the step (g) and upstream from the forming station.

Aspect 8: The method of any of aspects 6-7 and 9-11, wherein step (a) comprises driving the at least one chain in a continuous loop using a drive socket and step (h) comprises providing a cam located adjacent to the drive sprocket, engaging a clamp release surface with an outer surface of the cam, thereby causing the clamp of each of the plurality of links to disengage from the clamp grip surface at a location downstream from the step (g) and upstream from the forming station.

Aspect 9: The method of any of aspects 6-8 and 10-11, further comprising:

(i) using a stream of air to induce separation of any trim located on the clamp grip surface at a location at which step (h) is being performed.

Aspect 10: The method of any of aspects 6-9 and 11, wherein step (i) comprises blowing a stream of air to induce separation of any trim located on the clamp grip surface at a location at which step (h) is being performed.

Aspect 11: The method of any of aspects 6-10, wherein step (i) comprises using a vacuum stream to induce separation of any trim located on the clamp grip surface at a location at which step (h) is being performed.

Aspect 12: A method of retrofitting a fully assembled thermoforming machine to provide a secondary trim portion release, the thermoforming machine having two chains that each travel in a continuous loop, each of the two chains being guided by a plurality of sprockets and driven by a drive socket that is attached to a drive axle, each of the two chains including a plurality of links, each of the plurality of links having a clamp grip surface, a clamp that is biased to engage the clamp grip surface and a clamp release surface that is rigidly connected to the clamp, the method comprising the step of:

attaching a cam comprising at least two parts to the drive axle in a position adjacent to the drive sprocket, the cam having an outer surface that is positioned to engage the clamp release surface of each of the plurality of links as each of the plurality of links passes over the drive sprocket, thereby causing the clamp to temporarily disengage from the clamp surface.

1. A thermoforming system comprising:
a frame;
a forming station, a loading station, and a sealing station;
at least one chain, each of the at least one chain comprising a continuous loop having a plurality of links, each of the plurality of links having a clamp that is biased to engage a clamp grip surface and a clamp release surface that is operationally configured to cause the clamp to move out of contact with the clamp grip surface when the clamp release surface is pressed toward the clamp;
a plurality of sprockets including a drive sprocket, each of the plurality of sprockets being attached to an axle that is supported by the frame, each of the plurality of sprockets having teeth adapted to engage the at least one chain, the drive socket being connected to a drive mechanism operationally configured to provide a rotational movement of the drive socket in a first rotational direction, thereby causing each of the at least one chain to move in a first direction of travel;
a cutting station operationally configured to cut a trim portion away from a remaining portion of a thermoformed package being conveyed by the at least one chain, the cutting station including a first clamp disengagement device operationally configured to cause the clamp to disengage the clamp grip surface of each of the plurality of links as each of the plurality of links passes through the cutting station;
a supplemental clamp disengagement device comprising a cam located adjacent to at least one of the plurality of sprockets located between the cutting station and the forming station, the cam being affixed to the axle to which the at least one of the plurality of sprockets is attached, the cam having an outer surface that is positioned to engage the clamp release surface of each of the plurality of links as each of the plurality of links pass over the at least one of the plurality of sprockets, thereby causing the clamp to temporarily disengage the clamp grip surface.

2. The system of claim 1, wherein the cam is located adjacent to the drive sprocket.

3. The system of claim 1, wherein the cam comprises a plurality of parts that are removably attachable to each other, thereby enabling the cam to be installed on the axle while the at least one of the plurality of sprockets is installed on the axle.

4. The system of claim 1, further comprising a trim separation device that is operationally configured to apply a force to the trim portion in a direction that will cause the trim portion to disengage from the clamp grip surface and at a location in which the clamp is disengaged from the clamp grip surface of each of the plurality of links as each of the plurality of links pass over the at least one of the plurality of sprockets.

5. The system of claim 1, wherein the trim separation device comprises a blower or vacuum.

6. A method of operating a thermoform film machine, the method comprising the steps of:
(a) driving at least one chain in a direction of travel in a continuous loop, each of the at least one chain comprising a continuous loop having a plurality of links, each of the plurality of links having a clamp that is biased to remain in contact with a clamp grip surface and a clamp release surface that is operationally configured to cause the clamp to move out of contact with the clamp grip surface when the clamp release surface is pressed toward the clamp;
(b) forming at least one pocket in a package material at a forming station located along the continuous loop;
(c) sealing a cover over the package material at a sealing station;
(d) separating a trim portion from a thermoformed container at a cutting station after performing step (c);
(e) retaining the trim portion between a clamp and clamp grip surface of at least one link of the at least one chain after performing step (d);
(f) causing the clamp of each of the plurality of links to disengage from the clamp grip surface at a location downstream from step (d);
(g) allowing the clamp of each of the plurality of links to reengage the clamp grip surface at a location downstream from step (f) and upstream of step (h); and
(h) causing the clamp of each of the plurality of links to disengage from the clamp grip surface at a location downstream from the step (g) and upstream from the forming station.

7. The method of claim 6, wherein step (h) comprises providing a cam located adjacent to a sprocket, engaging a clamp release surface with an outer surface of the cam, thereby causing the clamp of each of the plurality of links to disengage from the clamp grip surface at a location downstream from the step (g) and upstream from the forming station.

8. The method of claim 6, wherein step (a) comprises driving the at least one chain in a continuous loop using a drive socket and step (h) comprises providing a cam located adjacent to the drive sprocket, engaging a clamp release surface with an outer surface of the cam, thereby causing the clamp of each of the plurality of links to disengage from the clamp grip surface at a location downstream from the step (g) and upstream from the forming station.

9. The method of claim 6, further comprising:
(i) using a stream of air to induce separation of any trim located on the clamp grip surface at a location at which step (h) is being performed.

10. The method of claim 9, wherein step (i) comprises blowing a stream of air to induce separation of any trim located on the clamp grip surface at a location at which step (h) is being performed.

11. The method of claim 9, wherein step (i) comprises using a vacuum stream to induce separation of any trim located on the clamp grip surface at a location at which step (h) is being performed.

12. A method of retrofitting a fully assembled thermoforming machine to provide a secondary trim portion release, the thermoforming machine having two chains that each travel in a continuous loop, each of the two chains being guided by a plurality of sprockets and driven by a drive socket that is attached to a drive axle, each of the two chains including a plurality of links, each of the plurality of links having a clamp grip surface, a clamp that is biased to engage the clamp grip surface and a clamp release surface that is rigidly connected to the clamp, the method comprising the step of:
attaching a cam comprising at least two parts to the drive axle in a position adjacent to the drive sprocket, the cam having an outer surface that is positioned to engage the clamp release surface of each of the plurality of links as each of the plurality of links passes over the drive sprocket, thereby causing the clamp to temporarily disengage from the clamp surface.
